(19) United States
(12) Patent Application Publication
(10) Pub. No.: US 2012/0221825 A1
(43) Pub. Date: Aug. 30, 2012

(54) NONVOLATILE MEMORY SYSTEM AND FEATURE INFORMATION SETTING METHOD

(75) Inventors: Beom Sik KIM, Icheon-si (KR); Young Soo PARK, Icheon-si (KR)

(73) Assignee: HYNIX SEMICONDUCTOR INC., Icheon-si (KR)

(21) Appl. No.: 13/340,796

(22) Filed: Dec. 30, 2011

(30) Foreign Application Priority Data
Feb. 28, 2011 (KR) 10-2011-0018195

(51) Int. Cl. G06F 12/00

(52) U.S. Cl. 711/170; 711/E12.001

(57) ABSTRACT

A nonvolatile memory system includes a controller and a nonvolatile memory apparatus, where the controller provides the nonvolatile memory apparatus with a first feature setting command or a second feature setting command according to device information of the nonvolatile memory apparatus in a mode change of the nonvolatile memory apparatus.

### CROSS-REFERENCES TO RELATED APPLICATION

The present application claims priority under 35 U.S.C. §119(a) to Korean application number 10-2011-0018195 filed on Feb. 28, 2011 in the Korean Intellectual Property Office, which is incorporated by reference in its entirety.

### BACKGROUND

1. Technical Field

The present invention relates to a semiconductor memory system, and more particularly, to a nonvolatile memory system and a feature information setting method.

2. Related Art

Flash memories have been extensively used in a variety of devices ranging from mobile electronic appliances to industrial systems. Accordingly, demands of host system supply companies may vary. However, it is difficult to manufacture flash memories differently for the different host systems employing the flash memories.

In this regard, an open NAND flash interface (ONFI) has been established as an interface standard capable of changing and using the operation mode of a flash memory apparatus according to the demands of host systems.

Flash memory apparatus may include a plurality of memory chips to improve operation speed, and may also perform interleaving, wherein the flash memory chips may have different device characteristics and interfaces. The flash memory apparatus with the plurality of memory chips may drive data to the whole chip or to a part of the chip according to the demands of host systems, and may operate in a synchronous manner or a non-synchronous manner. That is, the operation mode of the flash memory apparatus may be changed according to the demands of the host systems. When the operation mode is changed, it is necessary to perform a feature setting (Set Feature) process for changing the operation characteristics of the flash memory apparatus according to the demands of the host systems.

FIG. 1 is a timing diagram explaining a general feature setting process.

First, feature setting commands CMD and EFh and addresses ADDR and FA are input from a controller to a flash memory apparatus according to a mode change request of a host system. An address latch enable signal for data loading is activated (tADL passes), and then four sub-feature parameters P1 to P4 are sequentially input from the controller as feature setting data DIN.

After all of feature setting data is input, if a voltage setup time tWB passes, the flash memory apparatus transitions to a ready state (R/Bb is asserted to a low level) and stores (executes) the sub-feature parameters P1 to P4. The time required for executing the sub-feature parameters P1 to P4 is indicated by tFEAT.

The address FA for Set Feature defined by the ONFI standard is shown in Table 1 below, and may include a timing mode setting address 01h, an I/O drive strength setting address 10h, an EZ (ECC Zero) NAND control address 50h, and the like.

TABLE 1

| Feature Address | Description |
|---|---|
| 00h | Reserved |
| 01h | Timing Mode |
| 02h-0Fh | Reserved |
| 10h | I/O Drive Strength |
| 11h-1Fh | Reserved for programmable I/O settings |
| 20h-4Fh | Reserved |
| 50h | EZ NAND control |
| 51h-5Fh | Reserved |
| 60h-7Fh | Reserved for Block Abstracted NAND |
| 80h-FFh | Vendor specific |

The sub-feature parameters P1 to P4 transmitted after the input of the feature setting address FA are determined according to device information of the flash memory apparatus.

Table 2 below illustrates sub-feature parameters P1 to P4 for the timing mode setting address, Table 3 below illustrates sub-feature parameters P1 to P4 for the I/O drive strength setting address, and Table 4 below illustrates sub-feature parameters P1 to P4 for the EZ NAND control address, which have been defined in ONFI Revision 2.3.

TABLE 2

| Sub Feature | | | | | | | | |
|---|---|---|---|---|---|---|---|---|
| Parameter | 7 | 6 | 5 | 4 | 3 | 2 | 1 | 0 |

| | | | | |
|---|---|---|---|---|
| P1 | R | RC | Data Interface | Timing |
| | | | | Mode |
| | | | | Number |

| | |
|---|---|
| P2 | Reserved (0) |
| P3 | Reserved (0) |
| P4 | Reserved (0) |

TABLE 3

| Sub Feature | | | | | | | | |
|---|---|---|---|---|---|---|---|---|
| Parameter | 7 | 6 | 5 | 4 | 3 | 2 | 1 | 0 |

| | | |
|---|---|---|
| P1 | Reserved (0) | Drive |
| | | Strength |

| | |
|---|---|
| P2 | Reserved (0) |
| P3 | Reserved (0) |
| P4 | Reserved (0) |

TABLE 4

| Sub Feature | | | | | | | | |
|---|---|---|---|---|---|---|---|---|
| Parameter | 7 | 6 | 5 | 4 | 3 | 2 | 1 | 0 |

| | | |
|---|---|---|
| P1 | Reserved (0) | RD |

| | |
|---|---|
| P2 | Reserved (0) |
| P3 | Reserved (0) |
| P4 | Reserved (0) |

As described above, when the feature setting process is performed according to the ONFI standard, the four sub-feature parameters are input for the timing mode setting, the I/O drive strength setting, the EZ NAND control information setting, and the like. The flash memory apparatus then updates data corresponding to the sub-feature parameter, and performs the feature setting process.

Meanwhile, in the feature setting process, sub-feature parameters (default features) substantially equal to previously set sub-feature parameters are used in many cases. Such sub-feature parameters may be used as is without being updated. However, in the current feature information setting process, a process for inputting data substantially equal to previously set information after address transmission is unnecessarily performed in order to set sub-feature parameters substantially equal to previous sub-feature parameters, that is, default feature information.

Moreover, since the data input in the feature information setting is input for four cycles, time is wasted in order to input unnecessary data, resulting in the reduction in the operation speed of a memory system.

### SUMMARY

In one embodiment of the present invention, a nonvolatile memory system includes a controller and a nonvolatile memory apparatus, and the controller provides the nonvolatile memory apparatus with a first feature setting command or a second feature setting command according to device information of the nonvolatile memory apparatus in a mode change of the nonvolatile memory apparatus.

In another embodiment of the present invention, a nonvolatile memory system includes a controller and a nonvolatile memory apparatus, and the controller determines whether to transmit a feature setting address and feature setting data according to whether feature information is changed in a mode change of the nonvolatile memory apparatus.

In another embodiment of the present invention, a feature information setting method of a nonvolatile memory system including a controller and a nonvolatile memory apparatus includes determining by the controller whether to change feature information of the nonvolatile memory apparatus when a mode change request is received from a host, and determining by the controller whether to transmit a feature setting address and feature setting data according to a result of the determination.

### BRIEF DESCRIPTION OF THE DRAWINGS

Features, aspects, and embodiments are described in conjunction with the attached drawings:

FIG. 1 is a timing diagram explaining a general feature setting process;

FIG. 2 is a configuration diagram of an exemplary nonvolatile memory system according to an embodiment of the invention;

FIG. 3 is an exemplary flowchart explaining a feature information setting method of a nonvolatile memory system according to an embodiment of the invention; and

FIG. 4 is a timing diagram explaining an exemplary feature information setting method according to an embodiment of the invention.

### DETAILED DESCRIPTION

A nonvolatile memory system and a feature information setting method according to the present invention will be described in detail with reference to the accompanying drawings through exemplary embodiments.

FIG. 2 is a configuration diagram of an exemplary nonvolatile memory system according to an embodiment of the invention.

Referring to FIG. 2, a nonvolatile memory system 10 includes a controller 110 and a nonvolatile memory apparatus 120. Specifically, the nonvolatile memory apparatus 120 may include a plurality of chips.

The controller 110 includes a feature setting unit 112. When it is necessary to change a mode of the nonvolatile memory apparatus 120 according to the demands of a host (not illustrated), the feature setting unit 112 receives device information from the nonvolatile memory apparatus 120, and provides the nonvolatile memory apparatus 120 with feature information suitable for the device information so that the feature information can be set. To this end, the feature setting unit 112 sequentially provides the nonvolatile memory apparatus 120 with sub-feature parameters P1 to P4 as a feature setting command, a feature setting address, and feature setting data.

The feature setting unit 112 stores feature information corresponding to device information, interprets the device information transmitted from the nonvolatile memory apparatus 120, and provides feature information suitable for the device information.

In a mode change of the nonvolatile memory apparatus 120, feature information before change and feature information to be changed may be substantially equal to each other, or may be different from each other.

When the feature information is changed to be different from that in a previous mode, the feature setting unit 112 transmits a normal feature setting command which is a first feature setting command, an address ADDR, and feature setting data DIN, which is a sub-feature parameter, to the nonvolatile memory apparatus 120. The nonvolatile memory apparatus 120 stores the feature setting data DIN in a register 122, updates data of each address corresponding to the stored sub-feature parameter, and performs a feature setting process.

If the feature information is substantially equal to that in the previous mode so that there is no need to update the feature information, the feature setting unit 112 transmits only a default feature setting command, which is a second feature setting command, to the nonvolatile memory apparatus 120. In such a case, since the feature information is substantially equal to that in a previous operation mode, it is not necessary to transmit an address or a sub-feature parameter, except for the default feature setting command that indicates the necessity of a mode change.

When not considering a change in feature information before a mode change and feature information after a mode change, for example, ‘EFh’ may be used as a feature information setting command. However, when it is not necessary to change the feature information, a separate command, for example, ‘EAh’, may be allocated in order to transmit the default feature setting command. When the command EAh is received in a mode change, the nonvolatile memory apparatus 120 automatically calls a data value of each address corresponding to the sub-feature parameter stored in the register 122 in a previous mode change process, and performs a feature setting process.

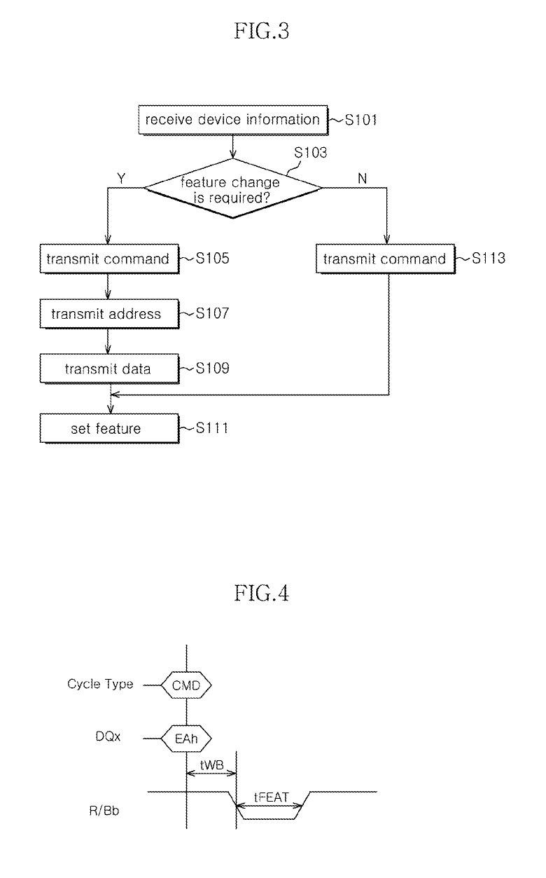

FIG. 3 is a flowchart explaining a feature information setting method of a nonvolatile memory system according to an embodiment of the invention.

As a host requires a mode change of the nonvolatile memory apparatus 120, the controller 110 receives device information from the nonvolatile memory apparatus 120 (S101). The device information may be provided at the request of the controller 110, or may be automatically provided by the nonvolatile memory apparatus 120.

When the device information is received, the feature setting unit 112 of the controller 110 compares the device information received in step S101 with device information in a previous mode, and checks if it is necessary to change feature information (S103).

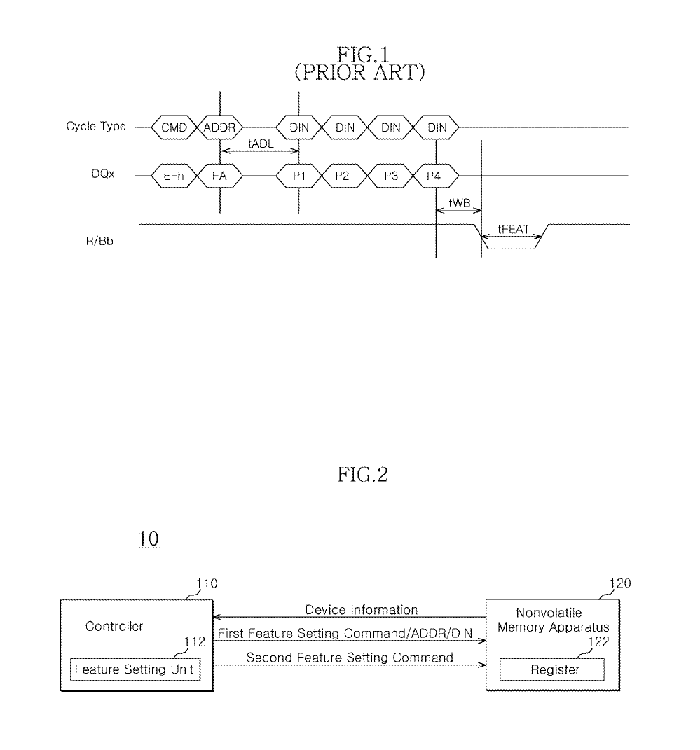

When it is necessary to change the feature information as a result of the check, the feature setting unit 112 sequentially transmits the normal feature setting command EFh, the address ADDR, and the feature setting data DIN, which is a sub-feature parameter, to the nonvolatile memory apparatus 120 (S105, S107, and S109). Then, the nonvolatile memory apparatus 120 stores the sub-feature parameter in the register 122, automatically calls a data value of each address corresponding to the stored sub-feature parameter, and performs a feature setting process (S111). Such a process may be performed as indicated by the timing diagram illustrated in FIG. 1.

Meanwhile, when it is not necessary to change the feature information, it is not necessary to transmit unnecessary address and data. Thus, the feature setting unit 112 transmits only the default feature setting command EAh to the nonvolatile memory apparatus 120 (S113).

As the default feature setting command EAh is received, the nonvolatile memory apparatus 120 performs a feature setting process without waiting until an address and data are received (S111).

FIG. 4 is a timing diagram explaining a feature information setting method according to the embodiment.

When the feature setting unit 112 of the controller 110 transmits the default feature setting command EAh as a feature setting command CMD, the nonvolatile memory apparatus 120 recognizes that it is not necessary to wait until a feature setting address or feature setting data is transmitted, and transitions to a ready state (R/Bb is activated to a low level) when a specified voltage setup time tWB passes. The nonvolatile memory apparatus 120 automatically calls a data value of each address corresponding to the sub-feature parameter stored in the register 122 in a previous operation mode change process during a feature setting time tFEAT, and performs a feature setting process.

In a mode change of the nonvolatile memory apparatus, when it is not necessary to change feature information set in a previous mode, it is possible to immediately perform a feature setting process using the default feature setting command without an input process of separate feature setting address and feature setting data.

When it is necessary to set feature information different from the feature information in the previous operation mode, the time required for the input of the normal feature setting command and the address, the time tADL required for activating the address latch enable signal for data loading, the time required for the input of the sub-feature parameters P1 to P4, the voltage setup time tWB, and the feature information setting time tFEAT, which are illustrated in FIG. 1, are required. However, when it is not necessary to change the feature information, since only the default feature setting command input time, the voltage setup time tWB, and the feature information setting time tFEAT are required, it is possible to significantly reduce the time required for setting the feature information.

As a consequence, it is possible to perform a mode change of the nonvolatile memory apparatus at a higher speed, and it is possible to save a resource required for transmitting unnecessary control signal or data.

While certain embodiments have been described above, it will be understood to those skilled in the art that the embodiments described are by way of example only. Accordingly, the nonvolatile memory system and the feature information setting method described herein should not be limited based on the described embodiments. Rather, the nonvolatile memory system and the feature information setting method described herein should only be limited in light of the claims that follow when taken in conjunction with the above description and accompanying drawings.

What is claimed is:

1. A nonvolatile memory system including a controller and a nonvolatile memory apparatus, wherein the controller is configured to provide the nonvolatile memory apparatus with a first feature setting command or a second feature setting command according to device information of the nonvolatile memory apparatus in a mode change of the nonvolatile memory apparatus.

2. The nonvolatile memory system according to claim 1, wherein, when it is not necessary to change feature information according to the device information, the controller transmits the second feature setting command to the nonvolatile memory apparatus.

3. The nonvolatile memory system according to claim 1, wherein, when it is necessary to change feature information according to the device information, the controller transmits the first feature setting command, a feature setting address, and feature setting data to the nonvolatile memory apparatus.

4. A nonvolatile memory system including a controller and a nonvolatile memory apparatus, wherein the controller is configured to determine whether to transmit a feature setting address and feature setting data according to whether feature information is changed in a mode change of the nonvolatile memory apparatus.

5. The nonvolatile memory system according to claim 4, wherein, when it is not necessary to change the feature information, the controller transmits a previously defined default feature setting command to the nonvolatile memory apparatus.

6. The nonvolatile memory system according to claim 4, wherein, when it is necessary to change the feature information, the controller transmits a previously defined normal feature setting command, a feature setting address, and feature setting data to the nonvolatile memory apparatus.

7. The nonvolatile memory system according to claim 4, wherein the controller is configured to receive device information from the nonvolatile memory apparatus when a mode change request is received from a host, and determine whether to change the feature information.

8. The nonvolatile memory system according to claim 7, wherein the controller is configured to substantially manage feature information according to the device information.

9. A feature information setting method of a nonvolatile memory system including a controller and a nonvolatile memory apparatus, the feature information setting method comprising:
determining by the controller whether to change feature information of the nonvolatile memory apparatus when a mode change request is received from a host; and
determining by the controller whether to transmit a feature setting address and feature setting data according to a result of determination.

10. The feature information setting method according to claim 9, wherein the controller manages feature information according to the device information.

11. The feature information setting method according to claim 9, wherein determining whether to change the feature information comprises:
receiving by the controller device information from the nonvolatile memory apparatus; and
comparing feature information corresponding to the received device information with feature information before a mode change.

12. The feature information setting method according to claim 9, further comprising:
transmitting by the controller a previously defined default feature setting command to the nonvolatile memory apparatus when it is not necessary to change the feature information.

13. The feature information setting method according to claim 9, further comprising:
transmitting by the controller a previously defined normal feature setting command, a feature setting address, and feature setting data to the nonvolatile memory apparatus when it is necessary to change the feature information.
